(19) United States
(12) Patent Application Publication
(10) Pub. No.: US 2026/0177431 A1
(43) Pub. Date: Jun. 25, 2026

(54) LOW-VOLTAGE BUSBAR MONITORING SYSTEM

(71) Applicant: XI'AN JIAOTONG UNIVERSITY, Xi'an (CN)

(72) Inventors: Hailong HE, Xi'an (CN); Yi WU, Xi'an (CN); Mingzhe RONG, Xi'an (CN); Chunping NIU, Xi'an (CN); Jingbo GAO, Xi'an (CN); Zhiguo WANG, Xi'an (CN)

(21) Appl. No.: 19/259,033

(22) Filed: Jul. 3, 2025

(30) Foreign Application Priority Data
Jul. 5, 2024 (CN) 2024108958385

(51) Int. Cl. G01K 3/00; G01K 1/02; G01K 1/024

(52) U.S. Cl. CPC G01K 3/005; G01K 1/024; G01K 1/026

(57) ABSTRACT

Disclosed in the present disclosure is a low-voltage busbar monitoring system. In the system, a plurality of wireless temperature sensors are mounted on surfaces of heat generating locations (also referred to as heat generating points, or simply heat points) of a busbar duct to periodically measure temperature data of each heat generating point in a self-powered mode and wirelessly transmit the temperature data of each heat generating point; one end of a heat-conducting base is connected to the heat generating points of the busbar duct, and the other end of the heat-conducting base is connected to a hot end of a thermal power-generating chip to conduct the temperature of the heat points to the hot end of the thermal power-generating chip by using heat conduction; a temperature sensing element is thermally conductively connected to the heat-conducting base to measure temperature data of the heat points.

### CROSS-REFERENCE TO RELATED APPLICATION

This application claims priority from the Chinese patent application 2024108958385 filed Jul. 5, 2024, the content of which are incorporated herein in the entirety by reference.

### TECHNICAL FIELD

The present disclosure relates to the technical field of wireless temperature measurement of low-voltage busbars, in particular a low-voltage busbar monitoring system.

### BACKGROUND

If the power supply and data transmission of a sensing network are wired, when there are a large number of sensors in the sensing network, sensor cables will bring a high installation cost and occupy a large space. If a sensor uses wireless communication and battery power supply, the cost of installation of the sensor can be reduced and flexibility of installation of the sensor can be increased. However, this manner also has disadvantages: when the power of a battery inside the sensor is depleted, the battery needs to be replaced manually, which significantly increases the maintenance cost of the sensing network, and discarded batteries also cause environmental problems.

The information disclosed in the Background section is only for enhancement of

understanding of the background of the present disclosure and thus may contain information that does not constitute the prior art that is well known to those of ordinary skill in the art.

### SUMMARY

In view of the deficiencies or defects in the prior art, provided is a low-voltage busbar monitoring system. Various mounting modes such as a threaded type, a pin type, a snap-fit type, an adhesive type, and a welding type of wireless temperature sensors are proposed depending on the mounting environment, a plurality of debugging and starting modes such as gasket triggering, infrared triggering, pressure-contact triggering, and a DIP switch are proposed according to the debugging and starting requirements, various communication modes such as WIFI, Bluetooth, lora, and Zigbee are proposed according to the requirements of the communication distance and communication power consumption to achieve temperature monitoring and alarm of heat generating points (i.e., surfaces of heat generating locations) of a busbar duct, predict busbar fault due to the problems such as power overload and insulation failure in advance, and ensure the reliable operation of a busbar system.

An object of the present disclosure is achieved by the following technical solutions.

a low-voltage busbar monitoring system includes:
a plurality of wireless temperature sensors mounted on surfaces of heat generating locations of a busbar duct to periodically measure temperature data of each heat generating point in a self-powered mode and wirelessly transmit the temperature data of each heat generating point, wherein each wireless temperature sensor includes:
a heat-conducting base, wherein one end of the heat-conducting base is connected to heat generating points of the busbar duct, and the other end of the heat-conducting base is connected to a hot end of a thermal power-generating chip to conduct the temperature of heat points to the hot end of the thermal power-generating chip by using heat conduction,
the thermal power-generating chip, including a hot end thermally conductively connected to the heat-conducting base and a cold end relative to the hot end, the thermal power-generating chip generating an electric energy based on a temperature difference between the cold end and the hot end,
a heat dissipating component connected to the cold end to transfer heat from the cold end to the environment by using heat conduction and heat convection,
a temperature sensing element thermally conductively connected to the heat-conducting base to measure temperature data of the heat points, and
a circuit module connected to the thermal power-generating chip and the temperature sensing element to transform and store the electrical energy and process the temperature data and wirelessly transmit the temperature data;
a plurality of temperature data repeaters wirelessly communicatively connected to the wireless temperature sensors to receive the temperature data; and
a background data center communicatively connected to the temperature data repeaters, the background data center displaying the temperature data to determine a heat generating condition of a busbar, and issuing an alarm when the temperature data exceeds a threshold.

In the low-voltage busbar monitoring system, the background data center includes,
a wireless or wired communication module communicatively connected to the temperature data repeaters,
a data processing module, which stores and visually processes the temperature data, wherein the data processing module sets the storage time of the temperature data, and a maximum threshold and a minimum threshold of the temperature data according to a usage demand, and calculates a change rate of the temperature data, and a difference of temperature data of different temperature measuring channels, and
a display module connected to the data processing module to reflect a temperature change trend based on the temperature data, and perform screen alarm when the temperature is abnormal.

In the low-voltage busbar monitoring system, the display module includes a liquid crystal screen, a dot matrix screen or a touch screen, and the display module displays real-time data and a change trend of the temperature and fits out a corresponding graph, and performs screen alarm according to the set maximum threshold and minimum threshold of the temperature data.

Preferably, the wireless or wired communication module includes wireless communication modes of WIFI, Bluetooth, lora, and Zigbee or wired communication modes of a serial port, USB, and RS485.

Preferably, the heat-conducting base is mounted in a threaded manner, a pinned manner, a snap-fit manner, an adhesive manner or a welding manner.

Preferably, a material of the heat-conducting base comprises silver, copper, aluminum, iron, or aluminum nitride ceramic.

Preferably, each wireless temperature sensor further includes a heat insulating component for isolating the heat dissipating component from the heat-conducting base.

Preferably, the circuit module is mounted around or inside the heat-conducting base.

Preferably, the circuit module includes circuit debugging or starting modes of gasket triggering, infrared triggering, pressure-contact triggering, and a DIP switch, wherein a circuit is operated for a period of time to enter a sleep state after the wireless temperature sensors are triggered in the absence of a heat source, and a battery is operated continuously after the wireless temperature sensors are triggered in the presence of a heat source.

Preferably, the low-voltage busbar monitoring system further includes a power supply module connected to the temperature data repeaters and the background data center, the power supply module including a rechargeable battery or a power supply cable.

Compared with the prior art, the present disclosure has the following beneficial effects:

In the present disclosure, the wireless temperature sensors are mounted on the surfaces of the heat generating locations (also referred to as heat generating points, or simply heat points) of the busbar duct, is self-powered by the Seebeck effect by using the temperature difference between the heat source and the environment, and can periodically measure the temperature data of each heat generating point and transmit the temperature data to the temperature data repeaters via wireless communication; the temperature data repeaters are powered by a wired mode or a battery, communicate with the plurality of wireless temperature sensors and receive the temperature data, and transmit the temperature data to the background data center by a wireless/wired communication mode; and the background data center receives the temperature data of the temperature data repeaters, and can display the temperature data to determine the heat generating condition of the busbar, and issue an alarm when the temperature data exceeds the threshold. The system is very suitable for long-term operation in an industrial environment to collect temperature data, which is of great significance to the development of industrial intelligence. The temperature monitoring and alarm of the heat generating points of the busbar are realized, busbar fault due to the problems such as power overload and insulation failure is predicted in advance, and the reliable operation of a busbar system is ensured.

The above description is only an overview of the technical solutions of the present disclosure, and in order to make the technical means of the present disclosure more clearly understood, to the extent that those skilled in the art can implement the present disclosure in light of the contents of the specification, and in order to make the above and other objects, features and advantages of the present disclosure more readily understood, specific embodiments of the present disclosure are exemplified below.

### BRIEF DESCRIPTION OF DRAWINGS

Various additional advantages and benefits of the present disclosure will become apparent to those of ordinary skill in the art upon reading the following detailed description of the preferred specific embodiments. The drawings are only for the purpose of illustrating the preferred embodiments and are not to be construed as limiting of the present disclosure. Obviously, the drawings described below are merely some embodiments of the present disclosure, for those of ordinary skill in the art, other drawings can also be obtained according to these drawings under the premise of paying no inventive step. Also, the same reference numerals are used to indicate the same parts throughout the drawings.

In the drawings:
FIG. 1 is a schematic structural diagram of a temperature measurement system according to an embodiment of the present disclosure;
FIG. 2 is a schematic structural diagram of a wireless temperature sensor of the temperature measurement system according to the embodiment of the present disclosure;
FIG. 3 is a schematic structural diagram of a wireless temperature sensor of a temperature measurement system according to another embodiment of the present disclosure;
FIG. 4 is a schematic diagram of a mounting manner of a wireless temperature sensor according to an embodiment of the present disclosure; and
FIG. 5 is a schematic topological diagram of a circuit module of a wireless temperature sensor according to an embodiment of the present disclosure.

The present disclosure is further explained below with reference to the accompanying drawings and the embodiments.

### DETAILED DESCRIPTION OF THE INVENTION

Specific embodiments of the present disclosure will be described in more detail below with reference to FIGS. 1 to 5. Although specific embodiments of the present disclosure are illustrated in the drawings, it should be understood that the present disclosure may be implemented in various forms and should not be limited by the embodiments set forth herein. Rather, these embodiments are provided in order to enable a more thorough understanding of the present disclosure and to fully convey the scope of the present disclosure to those skilled in the art.

It should be noted that certain terms are used throughout the description and claims to refer to certain components. It will be appreciated by those skilled in the art that different terms may be used to refer to the same component by those skilled. In the description and claims, differences in nouns are not used as a way of distinguishing components, but differences in function of components are used as criteria for distinguishing. “Comprising” or “including,” as referred to throughout the description and claims, is an open-ended term, so the term should be construed as “including, but not limited to.” The following description is to describe preferred embodiments for carrying out the present disclosure, but the description is for the purpose of general principles of the specification and is not intended to limit the scope of the present disclosure. The scope of the present disclosure is defined by the appended claims.

In order to facilitate an understanding of the embodiments of the present disclosure, description will be further made below by taking several specific embodiments as an example with reference to the accompanying drawings, and the accompanying drawings are not to be construed as limiting the embodiments of the present disclosure.

For a better understanding, as shown in FIGS. 1 to 5, a low-voltage busbar monitoring system includes:
a plurality of wireless temperature sensors 1 mounted on surfaces of heat generating locations (also referred to as heat generating points, or simply heat points) of a busbar duct to periodically measure temperature data of each heat generating point in a self-powered mode and wirelessly transmit the temperature data of each heat generating point, wherein each wireless temperature sensor 1 includes:
a heat-conducting base 105, wherein one end of the heat-conducting base 105 is connected to the heat generating points of the busbar duct, and the other end of the heat-conducting base 105 is connected to a hot end of a thermal power-generating chip 103 to conduct the temperature of the heat points to the hot end of the thermal power-generating chip 103 by using heat conduction,
the thermal power-generating chip 103, including a hot end thermally conductively connected to the heat-conducting base 105 and a cold end relative to the hot end, the thermal power-generating chip 103 generating an electric energy based on a temperature difference between the cold end and the hot end,
a heat dissipating component 101 connected to the cold end to transfer heat from the cold end to the environment by using heat conduction and heat convection,
a temperature sensing element 104 thermally conductively connected to the heat-conducting base 105 to measure temperature data of the heat points, and
a circuit module 106 connected to the thermal power-generating chip 103 and the temperature sensing element 104 to transform and store the electrical energy and process the temperature data and wirelessly transmit the temperature data;
a plurality of temperature data repeaters wirelessly communicatively connected to the wireless temperature sensors 1 to receive the temperature data; and
a background data center communicatively connected to the temperature data repeaters, the background data center displaying the temperature data to determine a heat generating condition of a busbar, and issuing an alarm when the temperature data exceeds a threshold.

In a preferred embodiment of the low-voltage busbar monitoring system, the background data center includes:
a wireless or wired communication module communicatively connected to the temperature data repeaters,
a data processing module, which stores and visually processes the temperature data, wherein the data processing module sets the storage time of the temperature data, and a maximum threshold and a minimum threshold of the temperature data according to a usage demand, and calculates a change rate of the temperature data, and a difference of temperature data of different temperature measuring channels, and
a display module connected to the data processing module to reflect a temperature change trend based on the temperature data, and perform screen alarm when the temperature is abnormal.

In a preferred embodiment of the low-voltage busbar monitoring system, the display module includes a liquid crystal screen, a dot matrix screen or a touch screen, and the display module displays real-time data and a change trend of the temperature and fits out a corresponding graph, and performs screen alarm according to the set maximum threshold and minimum threshold of the temperature data.

In a preferred embodiment of the low-voltage busbar monitoring system, the wireless or wired communication module includes wireless communication modes of WIFI, Bluetooth, lora, and Zigbee or wired communication modes of a serial port, USB, and RS485.

In a preferred embodiment of the low-voltage busbar monitoring system, the heat-conducting base 105 is mounted in a threaded manner, a pinned manner, a snap-fit manner, an adhesive manner or a welding manner.

In a preferred embodiment of the low-voltage busbar monitoring system, a material of the heat-conducting base 105 includes silver, copper, aluminum, iron or aluminum nitride ceramic.

In a preferred embodiment of the low-voltage busbar monitoring system, each wireless temperature sensor 1 further includes a heat insulating component for isolating the heat dissipating component 101 from the heat-conducting base 105.

In a preferred embodiment of the low-voltage busbar monitoring system, the circuit module 106 is square, round hole-shaped or polygonal.

In a preferred embodiment of the low-voltage busbar monitoring system, the circuit module 106 is mounted around or inside the heat-conducting base.

In a preferred embodiment of the low-voltage busbar monitoring system, the circuit module 106 includes circuit debugging or starting modes of gasket triggering, infrared triggering, pressure-contact triggering, and a DIP switch, wherein a circuit is operated for a period of time to enter a sleep state after the wireless temperature sensors 1 are triggered in the absence of a heat source, and a battery is operated continuously after the wireless temperature sensors 1 are triggered in the presence of a heat source.

In another embodiment,
there are two starting modes of the circuit module:
First mode: by detecting the open circuit voltage of the thermal power-generating chip, when the open circuit voltage is greater than a set threshold, a starting circuit starts to work, and wakes up the whole circuit module for temperature data sampling and wireless communication, and when the open circuit voltage is less than the set threshold, the circuit module re-enters the sleep state; and
Second mode: the circuit module is started through the set trigger port, and after a trigger condition is satisfied, the circuit module operates for a certain period of time and automatically enters the sleep state again. In this case, a trigger mode includes, for example, infrared triggering, pressure-contact triggering, and DIP triggering.

In another embodiment,
the communication frequency of a wireless communication circuit in the circuit module can be switched according to the specific situation of the temperature data, and low-frequency communication is adopted when the temperature data is in a safe range, and high-frequency communication is adopted when the temperature difference data is out of the safe range.

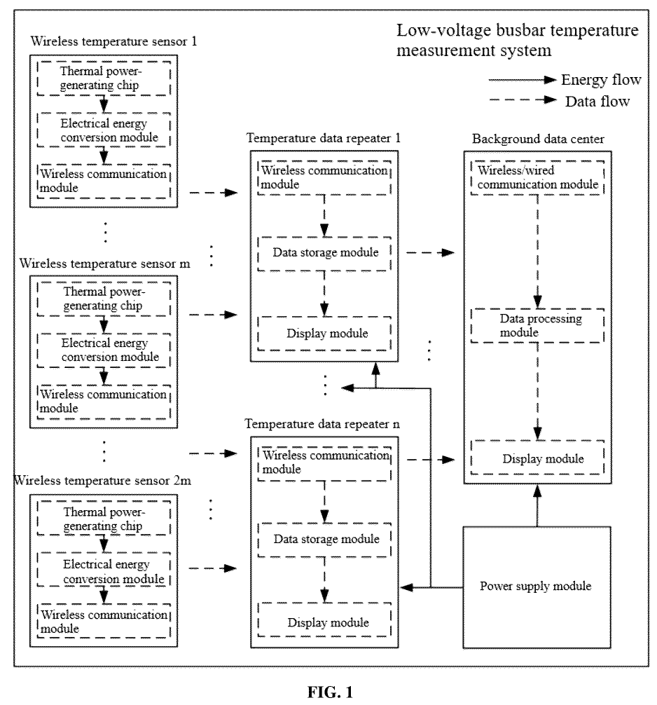

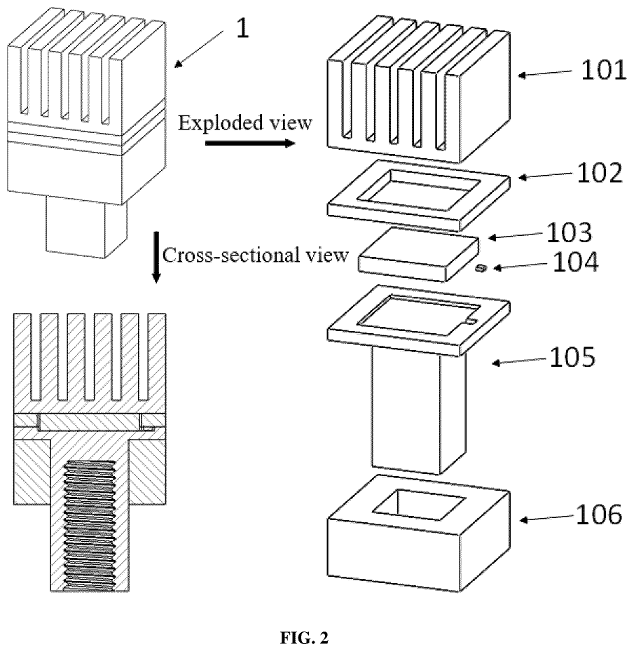

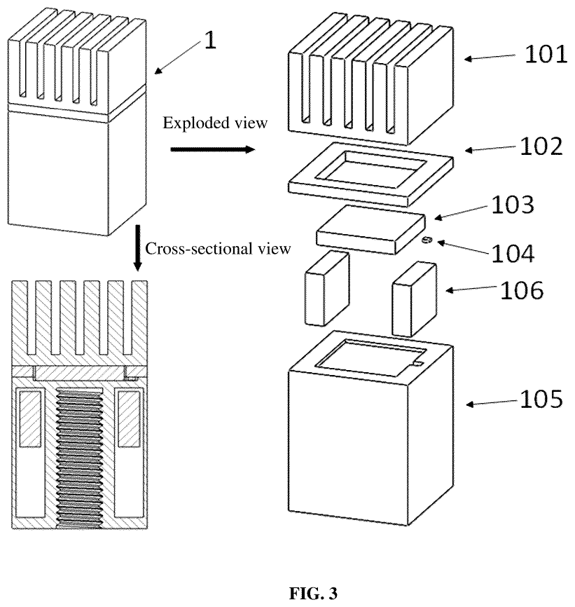

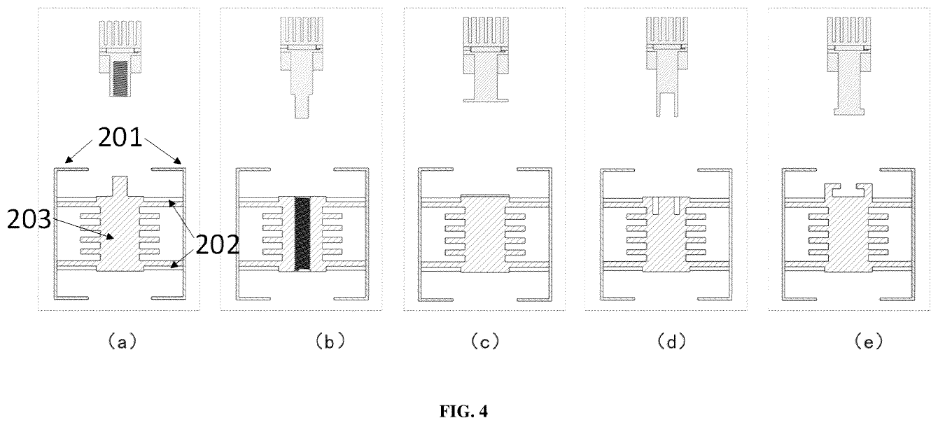

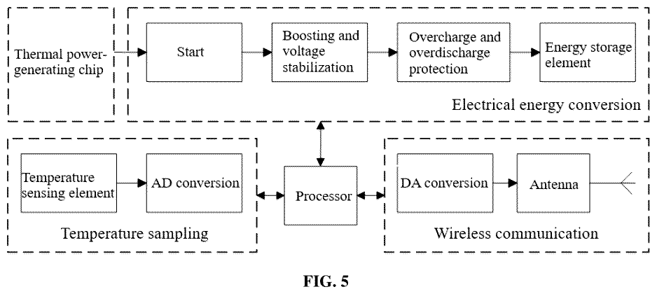

In another embodiment, referring to FIG. 5,
when the temperature difference between the heat source and the environment is greater than 10° C., the sensors start to operate, and the output electric energy of the thermal power-generating chip is collected by an electric energy conversion circuit inside and stored in an energy storage element after being subjected to boosting, and the energy storage element provides electric energy to ensure that temperature sampling and the wireless communication circuit continuously operate. When the temperature difference between the heat source and the environment is less than 10° C., the sensors stop working and no longer perform temperature sampling and wireless communication.

Further, the operating state of the wireless temperature sensors can be divided into four types according to the amount of power of the energy storage element in the wireless temperature sensors and whether the temperature difference between the external heat source and the environment is less than 10° C.:
Operating state 1: the energy storage element has sufficient power and the temperature difference is greater than 10° C.: at this time, circuits in the sensors start to work, the sensors can perform temperature sampling and wireless communication immediately, the thermal power-generating chip can charge the energy storage element, and the power of the energy storage element is always greater than a minimum power threshold. After the temperature difference is less than 10° C., the sensors enter an operating state 2.

Operating state 2: the energy storage element has sufficient power and the temperature difference is less than 10° C.: at this time, the circuits in the sensors stop working, the sensors no longer perform temperature sampling and wireless communication, the thermal power-generating chip cannot charge the energy storage element, and the energy storage element is slowly powered down at a self-discharge rate. The sensors re-enter the operating state 1 after the temperature difference is greater than 10° C. If the temperature difference is less than 10° C. for a long period of time and the power of the energy storage element is less than the minimum power threshold, the sensors enter an operating state 3.

Operating state 3: the energy storage element has insufficient power and the temperature difference is less than 10° C.: at this time, the circuits in the sensors stop working, the sensors no longer perform temperature sampling and wireless communication, the thermal power-generating chip cannot charge the energy storage element, and the energy storage element is slowly powered down at a self-discharge rate After the temperature difference is greater than 10° C., the sensors enter an operating state 4.

Operating state 4: the energy storage element has insufficient power and the temperature difference is greater than 10° C: at this time, the circuits in the sensors start to work, but the sensors do not perform temperature sampling and wireless communication, the thermal power-generating chip charges the energy storage element, the power of the energy storage element gradually rises until it is larger than the minimum power threshold, the sensors re-enter the operating state 1.

In a preferred embodiment of the low-voltage busbar monitoring system, the low-voltage busbar monitoring system further includes a power supply module connected to the temperature data repeaters and the background data center, the power supply module including a rechargeable battery or a power supply cable.

In one embodiment, the system includes wireless temperature sensors 1, temperature data repeaters and a background data center. Wherein the wireless temperature sensors 1 are mounted on the surfaces of the heat generating locations (also referred to as heat generating points, or simply heat points) of the busbar duct, is self-powered by the Seebeck effect by using the temperature difference between the heat source and the environment, and can periodically measure the temperature data of each heat generating point and transmit the temperature data to the temperature data repeaters via wireless communication; the temperature data repeaters are powered by a wired mode or a battery, communicate with the plurality of wireless temperature sensors 1 and receive the temperature data, and transmit the temperature data to the background data center by a wireless/wired communication mode; and the background data center receives the temperature data of the temperature data repeaters, and can display the temperature data to determine a heat generating condition of a busbar, and issue an alarm when the temperature data exceeds a threshold.

Further, each wireless temperature sensor 1 includes a heat-conducting base 105, a thermal power-generating chip 103, a temperature sensing element 104, a heat insulating component 102, a heat dissipating component 101, a circuit module 106, and connecting components, and the above components are connected into a whole through the connecting components. One end of the heat-conducting base 105 is connected to a heat source, and the other end of the heat-conducting base 105 is connected to a hot end of the thermal power-generating chip 103 to conduct the temperature of the heat source to the hot end of the thermal power-generating chip 103 by heat conduction, and the heat dissipating component 101 is connected to a cold end of the thermal power-generating chip 103 to transfer heat from the cold end to the environment by heat conduction and heat convection. A temperature difference is generated between the cold end and the hot end of the thermal power-generating chip 103, and the thermal power-generating chip 103 starts to operate to supply power to the circuit module 106. Meanwhile, the temperature sensing element 104 is also connected with the heat-conducting base 105, and the heat-conducting base 105 conducts the temperature of the heat source to the temperature sensing element 104, and measurement is performed by the temperature sensing element 104. The circuit module 106 performs electric energy conversion and storage of the energy output from the thermal power-generating chip 103, and processes and wirelessly transmits signals output from the temperature sensing element 104.

Further, the temperature data repeaters are powered by a wired mode or a battery. Each temperature data repeater includes a wireless communication module, a data storage module and a display module. The wireless communication module can perform signal transmission with the plurality of wireless temperature sensors 1 for networking to realize timed transmission of the temperature data; the data storage module can perform address editing on each wireless temperature sensor 1, so that the actual mounting positions of the wireless temperature sensors 1 are in one-to-one correspondence to the edited addresses, and store temperature data of different wireless temperature sensors 1 into different memory spaces, waiting for reading by the background data center via wireless/wired communication; and the display module can display the temperature data of different wireless temperature sensors 1, i.e., different temperature measuring channels, and perform timed refreshing.

Further, the background data center is powered by a wired mode, and includes a wireless/wired communication module, a data processing module and a display module. The wireless/wired communication module can read temperature signals of the temperature data repeaters in a wireless/wired communication manner; the data processing module can perform long-term storage and visualization processing on the temperature signals transmitted by the temperature data repeaters; and the display module can display long-term temperature data, reflect a change trend of the temperature signals, and perform screen alarm when the temperature is abnormal.

Further, the role of the heat-conducting base 105 of the wireless temperature sensor 1 is to conduct the temperature of the heat source to the hot end of the thermal power-generating chip 103 as well as the temperature sensing element 104, so the heat transfer effect of the heat-conducting base 105 is required to be good, and materials with high heat conductivity such as silver, copper, aluminum, iron, and aluminum nitride ceramic need to be selected. The exterior of the heat-conducting base 105 may be wrapped, painted, or sprayed with a material having a low convective heat transfer coefficient to reduce heat dissipated from the side of the heat-conducting base 105 to the environment and improve thermal conductivity. A heat source to which the heat-conducting base 105 is connected is not limited to a busbar, but also includes heat sources with a similar structure such as a transformer and a switch cabinet. The shape and mounting mode of the heat-conducting base 105 can be adjusted according to the heat source, and the mounting mode can be designed as a threaded type, a pin type, a snap-fit type, an adhesive type, a welding type, and the like.

Further, the role of the heat dissipating component 101 of the wireless temperature sensor 1 is to be in contact with the cold end of the thermal power-generating chip 103, conducting heat from the cold end of the thermal power generating chip 103 to the environment by heat convection and heat radiation. In order to achieve a good heat dissipating effect, the heat dissipating component 101 should be made of a material having high heat conductivity such as silver, copper, aluminum and iron, a non-metallic material such as plastic or ceramic may also be used in consideration of weight limitation, and a radiation refrigeration material such as, an indium-tin light stabilizing material, gallium nitride, and rare earth fluoride may also be used in order to enhance heat radiation. In addition, in order to enhance heat convection, a contact area of the heat dissipating component 101 with the environment should be as large as possible, and some designs should be made on the heat dissipating component 101 to increase the heat dissipating area, such as the addition of sheet-like or needle-like fins.

Further, the thermal power-generating chip 103 of the wireless temperature sensor 1 has a hot end, a cold end and a voltage output port. According to the Seebeck effect, when the temperature of the hot end of the thermal power-generating chip 103 is greater than the temperature of the cold end, a heat flow flows from the hot end to the cold end, and a voltage will be generated at the voltage output port of the thermal power-generating chip 103 to power the circuit module 106 of the sensor; the shape of the thermal power-generating chip 103 can be processed into various shapes such as a polygon and a circle as needed, and the thermal power-generating chip 103 can be operated in a single-piece form or in a form in which a plurality of pieces of the thermal power-generating chips are stacked at the output port and are connected in series; a thermoelectric arm material contained in the thermal power-generating chip 103 can select Bi₂Te₃ alloy, PbTe alloy, SiGe alloy, etc. according to the operating temperature of the thermal power-generating chip 103; the temperature sensing element 104 may select a platinum resistor, an NTC thermistor, a (K-type, T-type, J-type, etc.) thermocouple, etc. according to the accuracy of temperature measurement and the temperature measurement range, and one or more temperature sensing elements 104 may be arranged on one wireless temperature sensor 1 according to the requirement of the number of the temperature measuring channels and the temperature measurement coverage range.

Further, the circuit module 106 of the wireless temperature sensor 1 may be placed around or inside a heat conducting component according to the mounting manner and the mounting area size; the circuit module 106 can be designed as a square, a round hole or other irregular polygons depending on the mounting manner; the circuit module 106 can select various circuit debugging or starting modes such as gasket triggering, infrared triggering, pressure-contact triggering, and a DIP switch according to the user's needs and the installation scenario. A circuit is operated for a period of time to enter a sleep state after the wireless temperature sensors 1 are triggered in the absence of a heat source, and a battery is operated continuously after the wireless temperature sensors 1 are triggered in the presence of a heat source.

Further, the wireless communication modules of the temperature data repeaters can be simultaneously networked with the plurality of wireless temperature sensors 1; and the storage space and the data emptying period of the data storage module can be adjusted according to the number of nodes of the wireless temperature sensors 1, and the temperature data transmission period.

Further, the display module of the temperature data repeater can select display modes such as a digital tube, an LED, and a TFT according to the requirements such as the cost, volume, display content, etc., the display content, font size and data update frequency of the display module can be set according to the requirements such as the number of nodes of the wireless temperature sensors 1, a data refresh rate, etc.

Further, the wireless/wired communication module of the background data center may select wireless communication modes such as WIFI, Bluetooth, lora, and Zigbee or wired communication modes such as a serial port, USB, and RS485 according to the conditions such as the installation scenario, cost, and distance; the data processing module can set the storage time of the temperature data, and a maximum threshold and a minimum threshold of the temperature data according to a usage demand, and calculate a change rate of the temperature data, and a difference of temperature data of different temperature measuring channels.

Further, the display module of the background data center can select display manners such as a liquid crystal screen, a dot matrix screen, and a touch screen according to usage needs, can display real-time data and a change trend of the temperature according to the user demand, can fit out corresponding graphs such as a column graph, a scatter graph, a line graph and the like, and perform screen alarm according to the set maximum threshold and minimum threshold of the temperature data.

In one embodiment, as shown in FIG. 2 and FIG. 3, the wireless temperature sensor 1 includes a heat dissipating component 101, a heat insulating component 102, a thermal power-generating chip 103, a temperature sensing element 104, a heat-conducting base 105, and a circuit module 106. One end of the heat-conducting base 105 is connected to a heat source, and the other end of the heat-conducting base 105 is connected to a hot end of the thermal power-generating chip 103 to conduct the temperature of the heat source to the hot end of the thermal power-generating chip 103 by heat conduction, and the heat dissipating component 101 is connected to a cold end of the thermal power-generating chip 103 to transfer heat from the cold end to the environment by heat conduction and heat convection; a temperature difference is generated between the cold end and the hot end of the thermal power-generating chip 103, and the thermal power-generating chip 103 starts to operate to supply power to the circuit module 106; the circuit module 106 may be placed around or inside a heat conducting component depending on the mounting area size; the circuit module 106 may be designed as a square, a circular hole, or other irregular polygons according to the mounting mode, and may select various circuit debugging or starting modes such as gasket triggering, infrared triggering, pressure-contact triggering, and a DIP switch according to the user's needs and the installation scenario. Meanwhile, the temperature sensing element 104 is also connected with the heat-conducting base 105, the heat-conducting base 105 conducts the temperature of the heat source to the temperature sensing element 104, and measurement is performed by the temperature sensing element 104; and the circuit module 106 performs electric energy conversion and storage of the energy output from the thermal power-generating chip 103, and processes and wirelessly transmits signals output from the temperature sensing element 104.

FIG. 4 shows a schematic cross-sectional view of a wireless temperature sensor and a low-voltage busbar connector. The role of the heat-conducting base of the wireless temperature sensor is to conduct the temperature of the heat source to the hot end of the thermal power-generating chip as well as the temperature sensing element, so it is required that the heat transfer effect of the heat-conducting base is good, and it is required to select materials with high heat conductivity such as silver, copper, aluminum, iron, aluminum nitride ceramic and the like; the exterior of the heat-conducting base may be wrapped, painted, or sprayed with a material having a low convective heat transfer coefficient to reduce heat dissipated from the side of the heat-conducting base to the environment and improve thermal conductivity. The shape and mounting mode of the heat-conducting base may be adjusted according to the condition of the heat source, and the mounting mode may be designed as a nut type represented by a, a bolt type represented by b, a snap-fit type represented by c, a pin type represented by d, or an adhesive type or a welding type represented by e as shown in FIG. 4. A heat source to which the heat-conducting base is connected in FIG. 4 is a low-voltage busbar connector, wherein 201 denotes a cover plate of the low-voltage busbar connector, 202 denotes a connecting side lug of the low-voltage busbar connector, and 203 denotes an internal busbar of the low-voltage busbar connector. It should be noted that the heat source to which the wireless temperature sensor of the present disclosure is connected is not limited to a busbar, but also includes heat sources with a similar structure such as a transformer and a switch cabinet.

In another embodiment,
the wireless temperature sensor is configured as follows: one end of the heat-conducting base is connected to the heat generating points of the busbar duct and the other end of the heat-conducting base is connected to the hot end of the thermal power-generating chip to conduct heat from the heat generating points to the hot end of the thermal power-generating chip by heat conduction. A heat radiator is connected to the cold end of the thermal power-generating chip to transfer heat from the cold end of the thermal power-generating chip to the environment by heat convection or heat radiation. A temperature difference is formed at both ends of the thermal power-generating chip to output an electric energy to continuously supply power to the circuit module. The temperature sensing element is thermally conductively connected to the heat-conducting base to measure temperature data of the heat generating points. The circuit module is connected to the thermal power-generating chip and the temperature sensing element to convert and store the electric energy, process the temperature data and wirelessly transmit the temperature data.

In another embodiment,
a temperature data repeater includes a wireless communication module, a data storage module and a display module. A plurality of temperature data repeaters may be provided. The temperature data repeaters are wirelessly communicatively connected to the wireless temperature sensors to receive the temperature data, and can perform address editing on different wireless temperature sensors, so that the actual mounting positions of the wireless temperature sensors are in one-to-one correspondence to the edited addresses.

In another embodiment,
a background data center includes a wireless/wired communication module, a data processing module and a display module. The background data center is communicatively connected to the temperature data repeaters, and can determine the form of busbar fault by calculating a change rate of the temperature data, and a difference of temperature data of different temperature measuring channels, and issue an alarm when the temperature data exceeds a threshold.

In another embodiment,
in order to achieve a good heat dissipating effect, the heat dissipating component can adopt materials with good heat conductivity such as silver, copper, aluminum, iron and the like. In addition, in order to enhance the heat dissipating effect of heat convection, a contact area of the heat dissipating component with the environment should be as large as possible, some designs should be made on the heat dissipating component to increase the heat dissipating area, such as the addition of sheet-like or needle-like fins. Non-metallic materials such as plastic, graphite, and ceramic can also be used sometimes in consideration of weight limitation, and radiation refrigeration materials with a strong infrared radiation ability, such as PVDF organic coatings, PDMS organic coatings, SiO₂ photonic crystals, and TiO₂ photonic crystals can also be used sometimes in consideration of volume limitation.

In another embodiment, disclosed in the present disclosure is a low-voltage busbar monitoring system, wherein a plurality of wireless temperature sensors are mounted at heat generating points of a busbar duct to periodically measure temperature data of each heat generating point of a busbar in a self-powered mode and wirelessly transmit the temperature data of each heat generating point. One end of a heat-conducting base is connected to the heat generating points of the busbar duct, and the other end of the heat-conducting base is connected to a hot end of a thermal power-generating chip to conduct the temperature of the heat generating points to the hot end of the thermal power-generating chip by using heat conduction. A heat radiator is connected to a cold end of the thermal power-generating chip to transfer heat from the cold end of the thermal power-generating chip to the environment by heat convection or heat radiation. A temperature difference is formed at both ends of the thermal power-generating chip to output an electric energy to continuously supply power to a circuit module. A temperature sensing element is thermally conductively connected to the heat-conducting base to measure temperature data of the heat generating points. The circuit module is connected to the thermal power-generating chip and the temperature sensing element to convert and store the electric energy, process the temperature data and wirelessly transmit the temperature data. A plurality of temperature data repeaters are wirelessly connected to the wireless temperature sensors to receive the temperature data. A background data center is connected to the temperature data repeaters, displays the temperature data to determine a heat generating condition of the busbar duct, and issues an alarm when the temperature data exceeds a threshold.

In another embodiment, also disclosed in the present disclosure is a low-voltage busbar monitoring system, including:
a plurality of wireless temperature sensors, a plurality of temperature data repeaters, and a background data center, wherein
the plurality of wireless temperature sensors are mounted on the heat generating surface of a busbar to periodically measure temperature data of each heat generating point of the busbar in a self-powered mode, and wirelessly transmit the temperature data of each heat generating point, each wireless temperature sensor including:
a heat conducting module, wherein one end of the heat conducting module is connected to a heat generating busbar, and the other end of the heat conducting module is connected to a hot end of a temperature difference power-generating chip to conduct the temperature of the heat generating busbar to the hot end of the temperature difference power-generating chip by using heat conduction,
a heat dissipating module, wherein one end of the heat dissipating module is in contact with outside air, and the other end of the heat dissipating module is connected to the hot end of the temperature difference power-generating chip to transfer heat from a cold end of the temperature difference power-generating chip to air by using heat conduction and heat convection,
the temperature difference power-generating chip, wherein one end of the temperature difference power-generating chip is connected to a heat conducting component, and the other end of the temperature difference power-generating chip is connected to a heat dissipating component, and an electric energy is generated by using a temperature difference of the hot end and the cold end of the temperature difference power-generating chip, so as to realize the electric energy supply of the wireless temperature sensors,
a circuit module, consisting of a starting circuit, a boosting circuit, a temperature sampling circuit, a protection circuit and a wireless communication circuit, wherein the circuit module is fixed at a specific position of the heat conducting component, and realizes a self-powered function of the wireless temperature sensors by collecting the output electric energy of the temperature difference power-generating chip and performing electric energy conversion, and
a temperature measurement module, consisting of the temperature difference power-generating chip and a three-wire platinum resistor, wherein the temperature difference power-generating chip is not only used for power generation but also can be used for temperature measurement, and the three-wire platinum resistor is fixed at the cold end of the temperature difference power-generating chip, and the temperature measurement module is combined with the temperature sampling circuit to periodically measure the temperature of the heat generating busbar;
the plurality of temperature data repeaters are installed within a common communication radius of the plurality of wireless temperature sensors, and are connected to the corresponding plurality of wireless temperature sensors by wireless signals to receive temperature data thereof;
the background data center is installed in a monitoring room, is connected to the corresponding temperature data repeaters through wired/wireless signals, receives and stores the temperature data, performs curve drawing and issues an alarm in abnormal situations; and
the low-voltage busbar monitoring system is used for realizing temperature monitoring and alarming of the heat generating points of the busbar, so as to predict busbar fault due to the problems of power overload, insulation failure and the like in advance, and ensure the reliable operation of a busbar system.

Further, exemplarily, the temperature measurement module includes two parts of the temperature difference power-generating chip and the three-wire platinum resistor. Through the Seebeck effect, the temperature difference power-generating chip can generate the electric energy when there is a temperature difference between the hot end and cold end, which satisfies the relationship ΔT*Seebeck coefficient=open circuit voltage, wherein the Seebeck coefficient is known. Thus, after determining ΔT, the open circuit voltage of the temperature difference power-generating chip can be calculated, and vice versa, after determining the open circuit voltage of the temperature difference power-generating chip, the temperature difference ΔT at both ends of the temperature difference power-generating chip can be calculated, and by measuring the temperature of the cold end through the three-wire platinum resistor, the temperature of the hot end of the temperature difference power-generating chip, that is, the heat generating temperature of the busbar, can be converted. Therefore, the temperature difference power-generating chip here has both a power generation function and a temperature measurement function.

In another embodiment,

there are two starting modes of the starting circuit in the circuit module. First mode: by detecting the open circuit voltage of the temperature difference power-generating chip, when the open circuit voltage is greater than a set threshold, the starting circuit starts to work, and wakes up the whole circuit module for temperature data sampling and wireless communication, and when the open circuit voltage is less than the set threshold, the circuit module re-enters the sleep state; and Second mode: the starting circuit is started through the set trigger port, and after a trigger condition is satisfied, the circuit module operates for a certain period of time and automatically enters the sleep state again. A trigger mode includes infrared triggering, pressure-contact triggering, and DIP triggering. The communication frequency of the wireless communication circuit in the circuit module can be switched according to the specific situation of the temperature data, and low-frequency communication is adopted when the temperature data is in a safe range, and high-frequency communication is adopted when the temperature difference data is out of the safe range.

In another embodiment,
a data processing module is implemented in the form of a background data center, and the background data center can store and visualize temperature data, and perform address editing on different wireless temperature sensors, so that the actual mounting positions of the wireless temperature sensors are in one-to-one correspondence to the edited addresses. The data processing module can set the storage time of the temperature data, and a maximum threshold and a minimum threshold of the temperature data according to the requirements, and calculate a change rate of the temperature data, and a difference of temperature data of different temperature measuring channels, whereby the health status of the busbar is determined. Low-frequency sampling is performed when the temperature data is in a safe range, and high-frequency sampling is performed and an alarm is issued when the temperature data is out of the safety range, and combined with the change rate of the temperature data, and the difference of the temperature data of different temperature measuring channels, busbar fault forms are determined, and specific busbar fault forms of poor contact, insulation failure, power overload and line short circuit are determined.

Although the basic principles of the present disclosure have been described above in connection with specific embodiments, it should be noted that the advantages, benefits, effects and the like mentioned in the present disclosure are only examples and not limitations, and these advantages, benefits, effects and the like cannot be considered to be necessary for various embodiments of the present disclosure. In addition, the specific details disclosed above are merely for the purpose of illustration and convenience of understanding, and are not intended to limit the disclosure, and the above details do not limit the present disclosure as having to be implemented with the above specific details.

The above description has been given for purposes of illustration and description. Furthermore, this description is not intended to limit embodiments of the present disclosure to the forms disclosed herein. Although a number of example aspects and embodiments have been discussed above, those skilled in the art will recognize certain variations, modifications, changes, additions and sub-combinations thereof.

1. A low-voltage busbar monitoring system, comprising,
a plurality of wireless temperature sensors mounted on surfaces of heat generating locations (also referred to as heat generating points, or simply heat points) of a busbar duct to periodically measure temperature data of each heat generating point in a self-powered mode and wirelessly transmit the temperature data of each heat generating point, wherein each wireless temperature sensor comprises:
a heat-conducting base, wherein one end of the heat-conducting base is connected to the heat generating points of the busbar duct, and the other end of the heat-conducting base is connected to a hot end of a thermal power-generating chip to conduct the temperature of the heat points to the hot end of the thermal power-generating chip by using heat conduction,
the thermal power-generating chip, comprising a hot end thermally conductively connected to the heat-conducting base and a cold end relative to the hot end, the thermal power-generating chip generating an electric energy based on a temperature difference between the cold end and the hot end,
a heat dissipating component connected to the cold end to transfer heat from the cold end to the environment by using heat conduction and heat convection,
a temperature sensing element thermally conductively connected to the heat-conducting base to measure temperature data of the heat points, and
a circuit module connected to the thermal power-generating chip and the temperature sensing element to transform and store the electrical energy and process the temperature data and wirelessly transmit the temperature data;
a plurality of temperature data repeaters wirelessly communicatively connected to the wireless temperature sensors to receive the temperature data; and
a background data center communicatively connected to the temperature data repeaters, the background data center displaying the temperature data to determine a heat generating condition of a busbar, and issuing an alarm when the temperature data exceeds a threshold.

2. The low-voltage busbar monitoring system according to claim 1, wherein the background data center comprises:
a wireless or wired communication module communicatively connected to the temperature data repeaters,
a data processing module, which stores and visually processes the temperature data, wherein the data processing module sets the storage time of the temperature data, and a maximum threshold and a minimum threshold of the temperature data according to a usage demand, and calculates a change rate of the temperature data, and a difference of temperature data of different temperature measuring channels, and
a display module connected to the data processing module to reflect a temperature change trend based on the temperature data, and perform screen alarm when the temperature is abnormal.

3. The low-voltage busbar monitoring system according to claim 2, wherein the display module comprises a liquid crystal screen, a dot matrix screen or a touch screen, and the display module displays real-time data and a change trend of the temperature and fits out a corresponding graph, and performs screen alarm according to the set maximum threshold and minimum threshold of the temperature data.

4. The low-voltage busbar monitoring system according to claim 2, wherein the wireless or wired communication module comprises wireless communication modes of WIFI, Bluetooth, lora, and Zigbee or wired communication modes of a serial port, USB, and RS485.

5. The low-voltage busbar monitoring system according to claim 1, wherein the heat-conducting base is mounted in a threaded manner, a pinned manner, a snap-fit manner, an adhesive manner or a welding manner.

6. The low-voltage busbar monitoring system according to claim 1, wherein a material of the heat-conducting base comprises silver, copper, aluminum, iron, or aluminum nitride ceramic.

7. The low-voltage busbar monitoring system according to claim 1, wherein each wireless temperature sensor further comprises a heat insulating component for isolating the heat dissipating component from the heat-conducting base.

8. The low-voltage busbar monitoring system according to claim 1, wherein the circuit module is mounted around or inside the heat-conducting base.

9. The low-voltage busbar monitoring system according to claim 1, wherein the circuit module comprises circuit debugging or starting modes of gasket triggering, infrared triggering, pressure-contact triggering, and a DIP switch, wherein a circuit is operated for a period of time to enter a sleep state after the wireless temperature sensors are triggered in the absence of a heat source, and a battery is operated continuously after the wireless temperature sensors are triggered in the presence of a heat source.

10. The low-voltage busbar monitoring system according to claim 1, further comprising a power supply module connected to the temperature data repeaters and the background data center, the power supply module comprising a rechargeable battery or a power supply cable.
